(19) United States
(12) Patent Application Publication
(10) Pub. No.: US 2013/0153809 A1
(43) Pub. Date: Jun. 20, 2013

(54) Blowing Machine Valve

(71) Applicant: Technoplan Engineering SA, Plan-les-Ouates (CH)

(72) Inventors: Daniel Jover, Grand-Lancy (CH); Pierre Bohrer, Vandoeures (CH)

(73) Assignee: Technoplan Engineering SA, Plan-les-Ouates (CH)

(21) Appl. No.: 13/713,979

(22) Filed: Dec. 13, 2012

(30) Foreign Application Priority Data
Dec. 14, 2011 (FR) 1161637

(51) Int. Cl. B29C 49/42

(52) U.S. Cl. CPC B29C 49/4289
USPC 251/366

(57) ABSTRACT

The present invention relates to a valve for a machine for blowing containers, comprising a hollow valve body with an axis, a lid, at least two sleeves moving along said axis in said chamber, at least one inlet and one outlet, and control means designed to move said sleeves in said chamber. The sleeves are mounted one inside the other and they form a channel for the passage of a blowing gas. Each sleeve containing another sleeve has at least one radial passage for passage of the blowing gas when it is aligned with said inlet.

This application claims priority benefits to French Patent Application 11 61637 filed Dec. 14, 2011, the entire disclosure of which is incorporated herein by reference.

### FIED OF THE INVENTION

The present invention relates to a valve for a machine for blowing containers, comprising a hollow valve body forming a generally cylindrical chamber with an axis, a lid, and at least two sleeves moving along said axis in said chamber, at least one inlet and one outlet, and control means making it possible to move said sleeves in said chamber, the position of said sleeves defining the open or closed state of said at least one inlet and said outlet.

### DESCRIPTION OF THE PRIOR ART

Many problems exist in the field of container blowing facilities. First, it is necessary to have a gas, such as air, at a high pressure in the vicinity of 40 bar to blow the containers in a mold. Traditionally, compressors are used to compress the necessary gas. However, in some blowing methods, pre-blowing of the preform that will transform into a container is first done, followed by the blowing strictly speaking. The pre-blowing is done at a pressure of approximately 10 bar, then the blowing reaches a pressure of 40 bar. A first way of obtaining these two working pressures is to use two compressors, one to generate the 10 bar pressure, and the other to generate the 40 bar pressure. However, using two compressors is expensive both in terms of the initial investment to purchase them and their upkeep.

Another method involves using only one compressor which compresses the gas to 40 bar, then expanding part of the compressed gas to 10 bar for the pre-blowing operation. This method is also not particularly advantageous, since energy is wasted to compress a gas whereof the pressure is reduced without having been used in the manufacturing process.

Furthermore, once the container has been formed by blowing, the compressed gas used (which is at a pressure of approximately 40 bar) is released into the open air, which wastes energy.

It has thus proven necessary to improve the known methods and machines to improve outputs and reduce energy waste.

Machines and methods making it possible to manufacture containers, in particular PET bottles, by blowing are known in the state of the art. French patent application 2 662 631, to which reference may for example be made, describes such a machine and method. According to the described method, a preform is used fastened to an air distributor in a mold, and the distributor is connected with a pressurized air source, said air being introduced into the preform so as to press the walls of the preform against the edges of the mold, thereby forming the desired container. in the method described in this application, a drawing cylinder is also used whereof the action, combined with that of the pressurized air, allows auto--regulation of the equilibrium between the axial and transverse deformation of the preform, which results in a combined drawing and blowing method. In the machine described in the patent application, the pressurized air blown into the preform is also used to actuate the drawing cylinder. Once the container is formed, the blowing air is discharged into the open air.

Prior publication WO 96/25285 describes another method for blowing containers, for example bottles, from a preform.

According to the known method, the preform is pre-blown at a pressure comprised between 8 and 12 bar, then the blowing strictly speaking is done by injecting air at 40 bar. Also in this document, the blowing gas is discharged into the open air once the container has been formed.

In all of these blowing machines, it is necessary to have one or more valves on the blowing machine to allow the supply of gas at least at two different pressures (pre-blowing and blowing) and the discharge, or even recovery, thereof. Using the multiple valves necessary to implement the methods described in the state of the art has drawbacks in terms of the costs, space, and bulk related to the ducts, not to mention the necessary upkeep.

valve making it possible to offset some of the aforementioned drawbacks is proposed in EP-A-2176053. Several superimposed configurable elements having a shared axis and forming a channel make it possible, through the movement of a sleeve, to block or allow the entry or exit of the blowing gas in the shaping mold of the container. The configurable structure of this valve makes it possible to adapt it easily to the desired number regarding the gas inlets and outlets. Nevertheless, the fact that independent elements are superimposed affects the bulk of the valve.

### SUMMARY OF THE INVENTION

The aim of the invention is to improve the known devices by decreasing the volume and cost of the valve.

More particularly, one aim of the invention is to propose a valve that can be used in blowing machines that is compact and easy to manufacture while being less expensive.

The container blowing machine valve according to the invention is characterized by the fact that said sleeves are mounted one inside the other and sliding sealably one inside the other and relative to the inner wall of said chamber; they form a channel for the passage of a blowing gas concentric to said axis; and each sleeve containing another sleeve has at least one radial passage for passage of the blowing gas when it is aligned with said inlet.

The advantage of this valve is the “nesting doll” structure of the sleeves, which makes it possible to decrease the volume of the valve, more particularly heightwise.

According to one embodiment, the valve is characterized in that it comprises three sleeves, two inlets and one outlet, a first sleeve making it possible to open and close a first inlet of the valve, a second sleeve making it possible to open and close a second inlet of the valve, and a third sleeve making it possible to open and close an cutlet of the valve.

Such a valve is suitable for a facility for blowing plastic bottles according to a method comprising a step for pre-blowing a preform, followed by a blowing step, the third step involving discharging the blowing gas in the formed bottle toward the open air or a gas recovery facility.

According to one preferred embodiment, the valve is characterized in that the control means making it possible to move said sleeves in said chamber comprise a sleeve-based actuating chamber closing an inlet of the valve or closing an outlet of the valve, each actuating chamber being connected to a pressurized gas feed that may be the same source that supplies high-pressure blowing gas.

According to one alternative embodiment, the valve is characterized in that said actuating chambers are formed for two chambers between shoulders and the inner wall of said chamber, a tapered end of the sleeves and the outer walls of the sleeves situated inside another sleeve and, for the third actuating chamber, by the lid, a tapered end of the sleeve and the inner wall of said chamber.

Preferably, the outer surface of said sleeves and the inner surface of the chamber are provided with annular sealing gaskets.

According to one embodiment, said sleeves are completely or partially made from plastic.

According to another alternative embodiment, said sleeves are made from metal, preferably aluminum.

The valve according to the invention will be better understood through the description of one embodiment thereof and the related figures. The valve is provided for a facility for blowing a container starting from a preform using three steps: pre-blowing at a pressure of approximately 4 to 15 bar, blowing at a pressure of approximately 35 to 50 bar, and expansion of the blowing gas contained in the formed container into the open air or recovery thereof in a recovery circuit or volume.

### DESCRIPTION OP THE DRAWINGS

FIG. 1 shows a cross-sectional view of a valve according to the invention with three sleeves in a first closing position of the gas inlets and outlets.

FIG. 2 shows a cross-sectional view of a valve according to the invention with three sleeves in a second position allowing gas to enter for pre-blowing.

FIG. 3 shows a cross-sectional view of the valve according to the invention with three sleeves in a third position allowing gas to enter for blowing.

FIG. 4 shows a cross-sectional view of a valve according to the invention. with three sleeves in a fourth position allowing gas to exit at the end of blowing.

### DESCRIPTION OF PREFFERED EMBODIMENTS

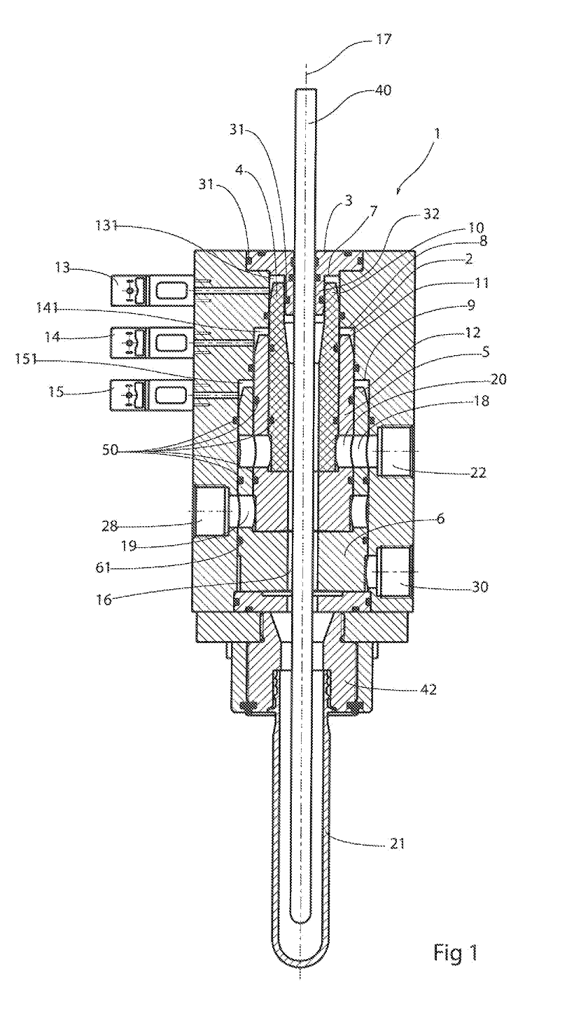

The valve is first described in reference to FIG. 1. This valve comprises a valve body 1 with a generally cylindrical chamber 2, with an axis 17 and a lid 3. Inside the chamber 2, there are three cylindrical sleeves 4, 5 and 6 that are movable along the axis 17. The upper sleeve 4 is located inside the following sleeve 5, which in turn is located inside the third sleeve 6. The three sleeves 4, 5, 6 can move relative to one another and relative to the inner wall of the chamber 2 in a sealed manner owing to several circular sealing gaskets 61,, The hollow portion of these three sleeves forms a channel 16 for the passage of the blowing gas. The lid 3 comprises a hollow cylindrical narrow part 32 housed in the upper portion of the sleeve 4, The hollow portion of the stopper 3 contributes to the continuity of the channel 16. Circular sealing gaskets 31 guarantee sealing of the assembly of the lid with the valve body 2 and the sleeve 4. In the chamber 2, there are two circular shoulders 8 and 9 that make it possible to adapt the inner diameter of the chamber 2 to the diameter of the sleeves 4 and 5. Furthermore, the inner wall of the chamber 2, the lid 3, and the tapered upper portions 10, 11, 12 of three sleeves 4, 5, 6 form actuating chambers 131, 141, 151 for the three sleeves 4, 5, 6. The three sleeves 4, 5, 5 may be made in part or in whole from a. plastic material. In certain applications, sleeves are used made from metal, in particular aluminum.

The positioning of the sleeves 4, 5 and 6 is determined by the actuating chambers 131, 141 and 151, which are supplied with pressurized gas (for example, air) by the devices 13, 14 and 15. Said pressurized gas may come from the source supplying gas for high-pressure blowing, i.e, the actuating chambers 134, 141, 151 are connected to the port 28. More specifically, the introduction of pressurized gas into the actuating chambers 131 to 151 makes it possible to move the sleeves 4 to 6 axially downward as illustrated in FIG. 1. The valve body is provided with three radial openings 22, 28 and 30. The opening 22 supplies pre-blowing gas, the opening 23 supplies blowing gas, and the opening 30 ensures discharge of the gas contained in the container after formation thereof,

The sleeve 6 has a radial passage 19 across from the opening 28, and a radial passage 18 across from the opening 22. The sleeve 5 has a radial passage 20 across from the opening 22 and in the continuation of the passage 18 of the sleeve 6. These three radial passages 18, 19 and 20 can pass through the corresponding sleeves over the entire diameter thereof, as shown in the figures, or only along the radius.

The described valve makes it possible to replace three separate valves in traditional facilities.

To understand the operation of this valve, we have diagrammatically shown the drawing cylinder 40 passing through the channel is from top to bottom, a preform 21 fastened to the valve by a support 42. The mold in which the preform will turn into a container.

In FIG. 1, the position of the three sleeves shows the valve in the closed position. The three actuating chambers 131, 141, 151 are pressurized by the gas coming from the devices 13, 14 and 15. As a result, the three sleeves 4, 5, 6 are in the low position and the gas coming from the ports 22 or 28 cannot enter the channel 16, and any gas contained in the preform 21 cannot escape through the port 30.

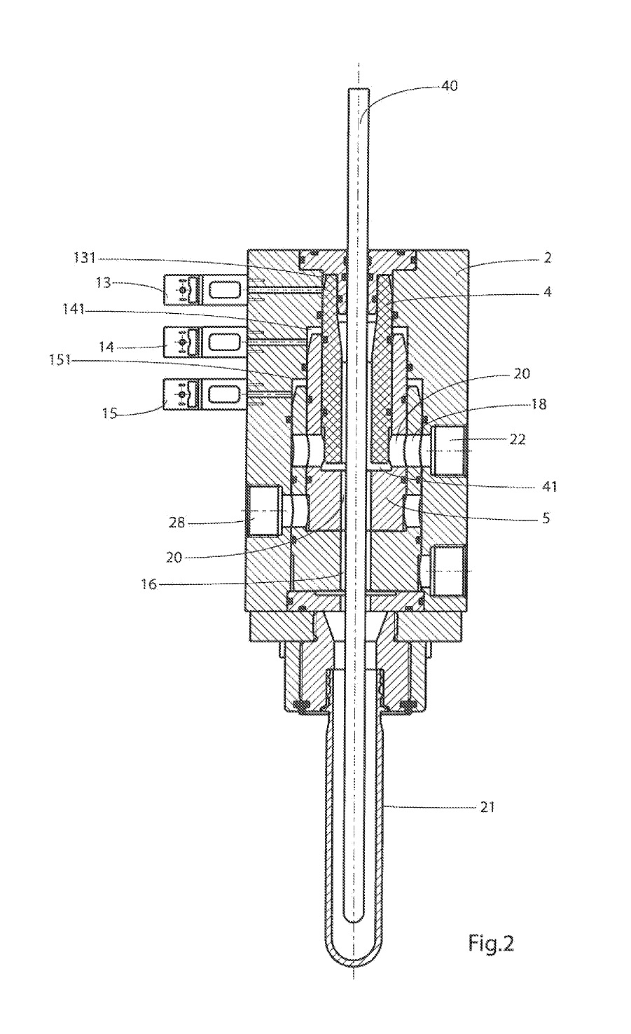

In FIG. 2, the position of the three sleeves shows the valve in the pre-blowing position. The device 13 is commanded to stop sending the control gas into the actuating chamber 131 and to allow the gas located therein to escape to the open air or into a recovery circuit or volume. The pre-blowing gas, which is at a pressure of 4 to 10 bars, supplies the pre-blowing port 22 passes through the channels 18 and 20. The pressure of the pre-blowing gas pushes the sleeve 4 upward, as shown in FIG. 2. The space 41 between the lower portion of the sleeve 4 and the surface of the sleeve 5 against which the sleeve 4 was bearing allows gas to enter the channel 20 and the preform 21.

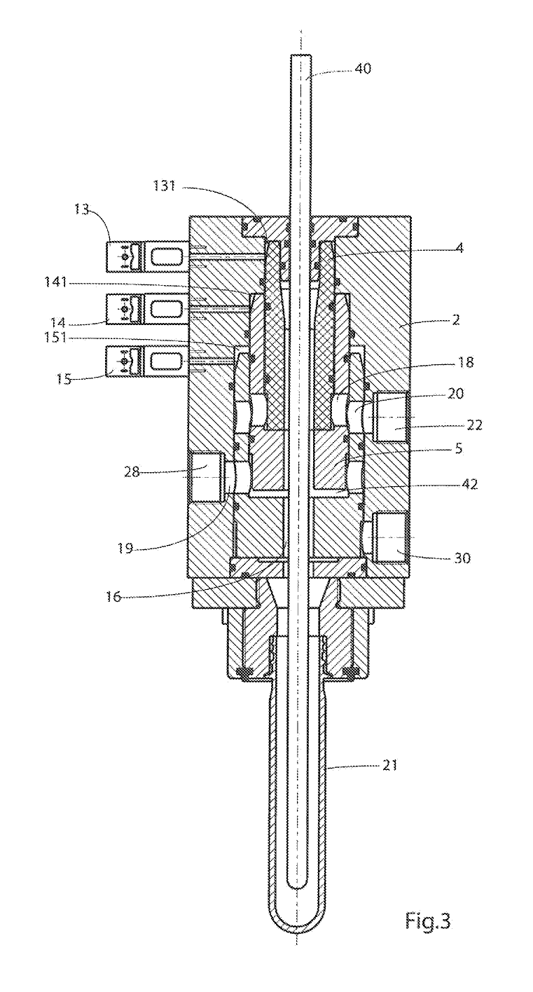

The position of the sleeves for blowing is shown in FIG. 3.

After the end of the pre-blowing step, the device 14 is commanded to stop sending the control gas into the actuating chamber 141 and to allow the gas located therein to escape to the open air or into a recovery circuit or volume. The blowing gas, which is at a pressure of 30 to 50 bars, supplies the blowing port 28 passes through the channel 19. The pressure from the blowing gas pushes the sleeve 5 upward, as shown in FIG. 3, and closes the communication of the channels 18 and 20 with the channel 16. The space 42 between the lower portion of the sleeve 5 and the surface of the sleeve against which the sleeve 4 was bearing allows gas to enter the channel 20 and to enter the preform 21 for blowing.

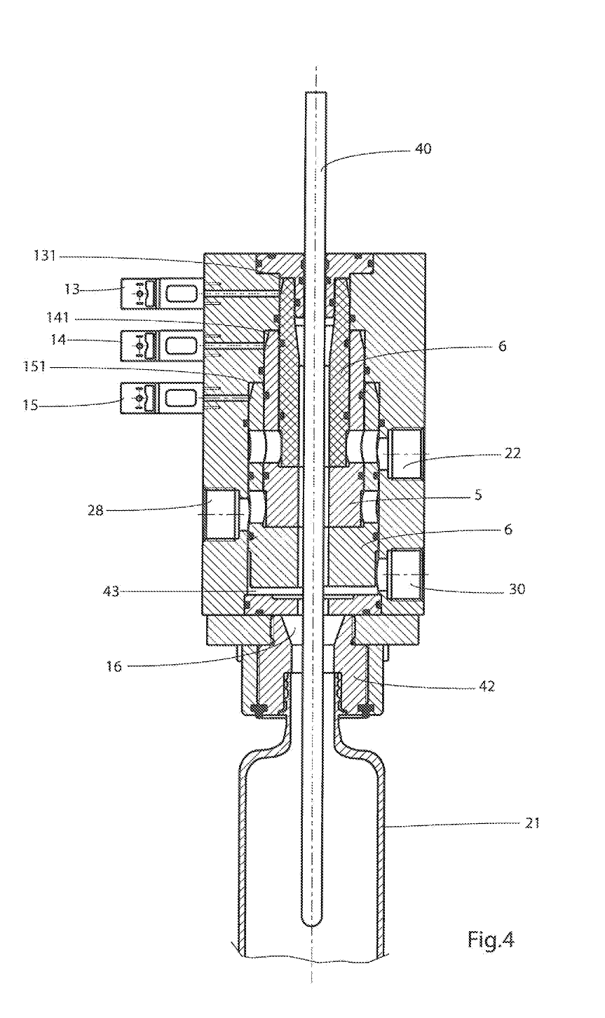

The position of the sleeves for the discharge of the blowing gas is shown in FIG. 4. At the end of blowing, the device 15 is commanded to stop sending the control gas into the actuating chamber 151 and to allow the gas located therein to escape to the open air or into a recovery circuit or volume. The blowing gas in the formed container 22, which is at a pressure of 30 to 50 bars, pushes the sleeve 6 upward, as shown in FIG. 4. The space 43 between the lower portion of the sleeve 6 and the surface of the chamber 2 against which the sleeve 5 was bearing allows gas to enter the port 30 to escape to the open air or a gas recovery circuit, in that state of the valve, all of the sleeves 4 to 6 are in the high position. In the discharge position, the passages 25, 26 and 29 are practically aligned, which allows the blowing gas to exit through the discharge channel 30 toward the outside of the container.. To simplify the illustration, the preform 21 has not changed shape in FIGS. 1 to 3, but it must be understood that during the pre-blowing, it changes shape.

After the discharge of the gas from the formed container, the container 212 is removed, the three actuating chambers are actuated, and the sleeves 4 to 6 come to the position shown in FIG. 1. A new preform is put, in and the process begins again. At the end of the pre-blowing and blowing, respectively, the gas supply is stopped.

In the considered example, which was described as one non-limiting embodiment, three sleeves have been described, since the valve needed three states (pre-blowing supply, blowing supply, and discharge), but this number may of course vary depending on the needs. This number may be decreased or increased by adding sleeves according to the principle of the valve described and using the means described above for its production.

One will also understand that the present valve is not limited to use in a blowing machine, but may be used for other applications as well.

What is claimed is:

1. A valve for a machine for blowing containers, comprising a hollow valve body forming a generally cylindrical chamber with an axis, a lid, and at least two sleeves moving along said axis in said chamber, at least one inlet and one outlet, and control means making it possible to move said sleeves in said chamber, the position of said sleeves defining the open or closed state of said at least one inlet and said outlet, wherein said sleeves are mounted one inside the other and sliding sealably one inside the other and relative to the inner wall of said chamber, in that they form a channel for the passage of a blowing gas concentric to said axis, and in that each sleeve containing another sleeve has at least one radial passage for passage of the blowing gas when it is aligned with said inlet.

2. The valve according to claim 1, wherein it comprises three sleeves, two inlets and one outlet, a first sleeve making it possible to open and close a first inlet of the valve, a second sleeve making it possible to open and close a second inlet of the valve, and a third sleeve making it possible to open and close an outlet of the valve.

3. The valve according to claim 1, wherein the control means making it possible to move said sleeves in said chamber comprise a sleeve-based actuating chamber closing an inlet of the valve or closing an outlet of the valve, each actuating chamber being connected to a pressurized gas feed.

4. The valve according to claim 3, wherein said actuating chambers are formed for two chambers between shoulders and the inner wall of said chamber, a tapered end of the sleeves and the outer walls of the sleeves situated inside another sleeve and, for the third actuating chamber, by the lid, a tapered end of the sleeve and the inner wall of said chamber.

5. The valve according to claim 1, wherein the outer surface of said sleeves and the inner surface of the chamber are provided with annular sealing gaskets.

6. The valve according to claim 1, wherein said sleeves are completely or partially made from plastic.

7. The valve according to claim 1, wherein said sleeves are made from metal, preferably aluminum.

8. The valve according to claim 2, wherein the control means making it possible to move said sleeves in said chamber comprise a sleeve-based actuating chamber closing an inlet of the valve or closing an outlet of the valve, each actuating chamber being connected to a pressurized gas feed.
